(19) United States
(12) Patent Application Publication
(10) Pub. No.: US 2009/0249257 A1
(43) Pub. Date: Oct. 1, 2009

(54) CURSOR NAVIGATION ASSISTANCE

(75) Inventors: Thomas Bove, Copenhagen OE (DK); Michael Rahr, Roskilde (DK)

Correspondence Address: Perman & Green, LLP, 99 Hawley Lane, Stratford, CT, 06614, US

(73) Assignee: NOKIA CORPORATION, Espoo (FI)

(21) Appl. No.: 12/059,253

(22) Filed: Mar. 31, 2008

(51) Int. Cl. G06F 3/048

(52) U.S. Cl. 715/858

(57) ABSTRACT

A system and method include transitioning a cursor on a display towards a target, detecting an active cursor navigation control field around the target, and automatically positioning the cursor in a center region of the target when the cursor reaches the cursor navigation control field.

### BACKGROUND

1. Field

The disclosed embodiments generally relate to user interfaces and, more particularly to cursor and pointer navigation control on a user interface.

2. Brief Description of Related Developments

Navigation input devices on mobile devices make analog navigation possible on for example webpages and maps. This means both 360° control as well as control of cursor speed. However, stopping on an intended target, for example a link on a webpage or a point of interest on the map, is difficult since it is very hard to balance the needs of high-speed with the needs of high precision on small targets.

Mobile devices such as cell phones have four or five keys to navigate menus, while other interfaces, such as Windows™ mobile or UIQ™ utilize mouse and pointer navigation devices. However, this compatibility is not optimal when using maps and navigating in a web browser. In those applications, the user needs to be able to move around with different speeds, slow for precision work, and fast with greater distances as on a map.

### SUMMARY

The aspects of the disclosed embodiments are directed to a system and method that includes transitioning a cursor on a display towards a target, detecting an active cursor navigation control field around the target, and automatically positioning the cursor in a pre-determined region of the target when the cursor reaches the cursor navigation control field.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A-2D illustrates examples of processes incorporating aspects of the disclosed embodiments;

FIG. 3 illustrates an exemplary application of aspects of the disclosed embodiments;

FIG. 4 illustrates an exemplary application of aspects of the disclosed embodiments;

FIG. 5 illustrates an exemplary application of aspects of the disclosed embodiments;

FIGS. 6A and 6B are illustrations of exemplary devices that can be used to practice aspects of the disclosed embodiments;

FIG. 6C is an illustration of an exemplary 360 degree navigation control that can be used in conjunction with aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(s)

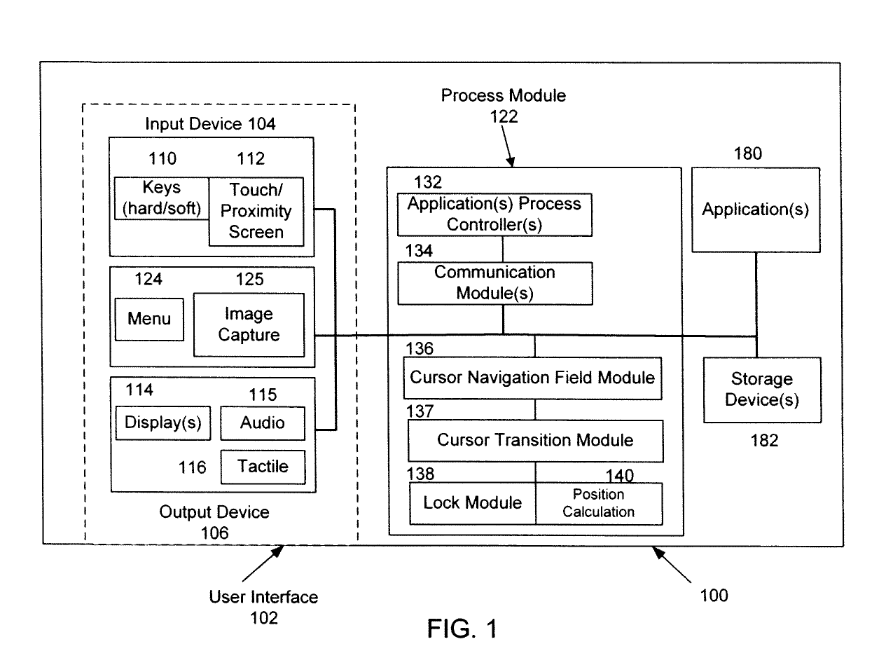

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

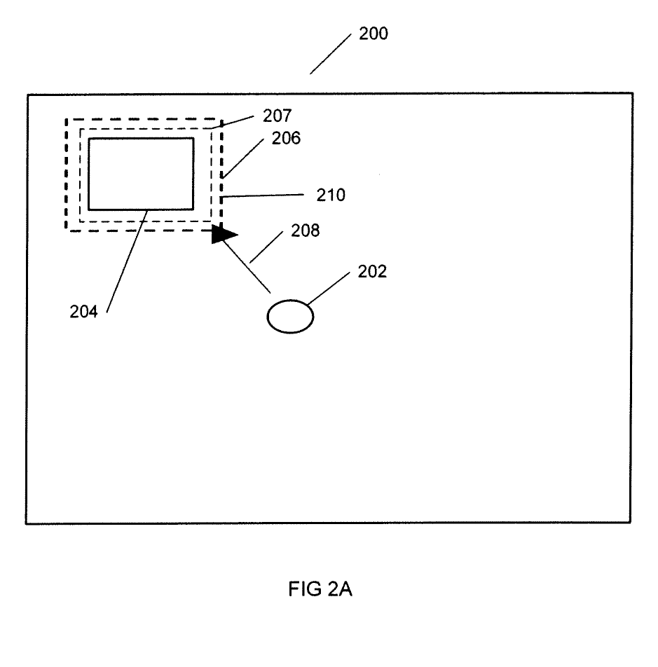

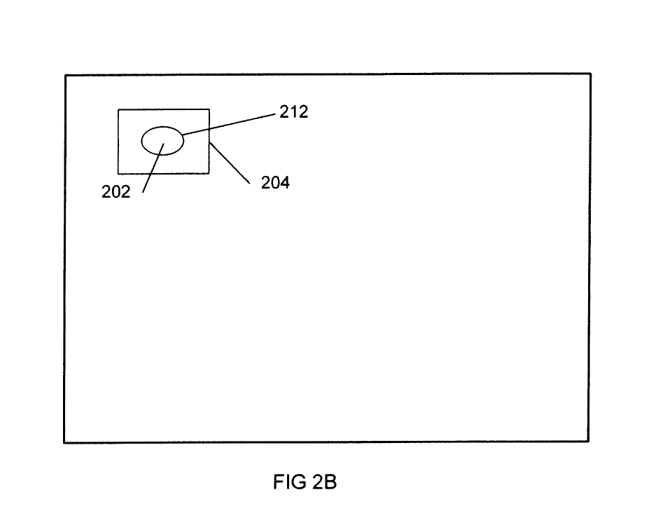

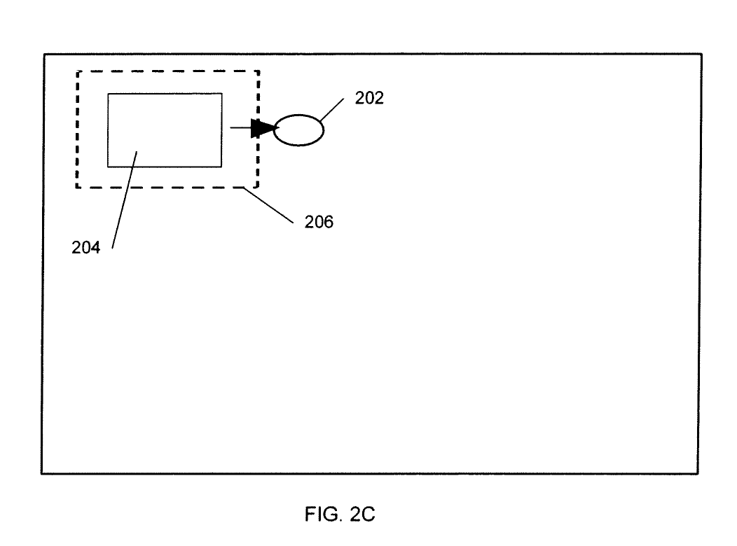

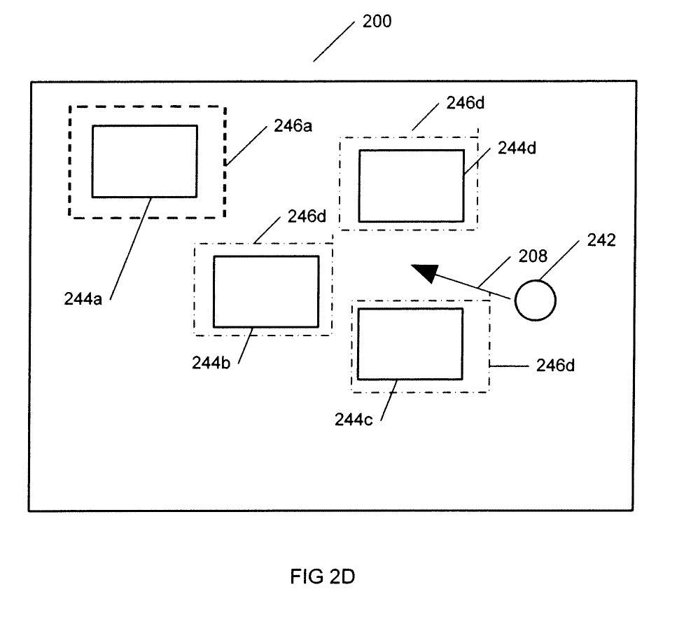

The aspects of the disclosed embodiments will significant improve navigation speed and precision on a display of a user interface of a device 100. As shown in FIG. 2A, a cursor navigation field 206 is provided in connection with and around a target 204 on a display 200 of a device. When the cursor navigation field 206 is active, as the cursor 202 is moved towards the target 204 and approaches the cursor navigation field 206, the cursor 202 will be drawn to the target 204 and positioned in a suitable location on the target 204. In one embodiment, this position can be in substantially a center area or region of the target 204. One might analogize this to a “tractor beam” effect. As displays become smaller and yet contain more information, it becomes difficult to easily and precisely navigate to various links, points of interest and other targets that are available for selection on the display. By being able to automatically navigate to a precise position on the display, it becomes easier for a user to navigate amongst the different links that are available. Maps and web browsers are examples of applications in which aspects of the disclosed embodiments can be applied. These applications can present numerous links on a display. Other examples of applications can include spreadsheets, text editing, regular user interface menus and messaging applications.

The aspects of the disclosed embodiments can be applied in both two-dimensional (2-D) and three-dimensional (3-D) user interface devices. For example, the automatic pointer positioning and locking described herein can be achieved in a 3-D device with respect to either the (X-Y) plane or the (X-Y-Z) plane, depending upon the application. Generally, the automatic cursor positioning of the disclosed embodiments navigates or moves the cursor or pointer in the (X-Y) directions on the user interface. In a 3-D application, the automatic cursor positioning can also include zooming in on a target, such as by focusing on a specific point of interest on a map. Thus, not only will the automatic cursor positioning described herein generally navigate the user to a target region (in the X-Y plane), but then can also navigate in the Z plane to provide a more focused or general view, depending upon the user requirements and settings.

Referring to FIGS. 2A-2C, an exemplary application of the disclosed embodiments is illustrated. A display 200 is shown that includes at least one target 204. Although only one target 204 is shown in the display 200 of FIG. 2A, it should be understood that a display 200 could include one or more targets 204. The target 204 can comprise any suitable item or object that can be presented on or in relation to a display or user interface, including for example, a link on a web page, a hypertext link in a document or other text style application, a point of interest (“POI”), such as a location on a map, a position in a gaming application, a picture, an image, an application icon, a text link, a communication identifier or address. In alternate embodiments, the target 204 can comprise any suitable object, item, position or icon on a display other than including the aforementioned examples.

As shown in FIG. 2A, a cursor navigation field or region 206 substantially surrounds the target 204. In one embodiment, the cursor navigation field 206 forms a perimeter region between an outside edge of the target 204 and the outside edge of the cursor navigation field 206. The depth, size and area of the perimeter region can be any suitable area. For example in one embodiment, the outside edge of the cursor navigation field 206 can be substantially the same as an outside edge of the target 204. The shape of the cursor navigation field 206 is not limited by the scope of the embodiments disclosed herein. While the cursor navigation field 206 shown in FIG. 2A is substantially the same shape as the target 204, in alternate embodiments the cursor navigation field 206 can comprise any suitable shape. Also, although the cursor navigation field 206 shown in FIG. 2A encompasses the entirety of the target 204 and is closed on all sides, in alternate embodiments the cursor navigation field 206 may only partially enclose or surround the target 204. For example, in one embodiment, the cursor navigation field 206 may only be formed on or be adjacent to those sides of the target 204 that are most likely to be approached by the cursor 202. In a situation where there a number of targets 204, being able to provide a navigation field 206 that is not the same shape as the target 204 can be advantageous. A particular advantage can exist where nearby objects, and/or the size of the display area of the user interface, make it difficult to have wide attraction fields 206 around the corresponding target 204.

In one embodiment the shape of a field 206 can be advantageously designed around a corresponding target 204 to maximize cursor navigation as described herein. For example, in one embodiment, it could be advantageous to provide a oblong shaped navigation field around a rectangular object. This could maximize a target area or location. Alternatively, it might be desired to provide a triangular shaped navigation field around a target, where the base of the triangle is oriented toward a direction from which it is anticipated the cursor would approach the target. The peak of the triangular field may be oriented closer to a edge of the display field where it is less likely that a cursor may approach from. This embodiment might be advantageous where it is desired to minimize the area occupied by the target region and field 206.

In the example shown in FIG. 2A the cursor navigation field 206 is active, meaning that it is available for targeting and positioning as described herein. A non-active field would be one that is not responsive to the automatic positioning of the disclosed embodiments. In one embodiment, some form of a highlighting of the field 206 may represent an active cursor navigation field 206. As shown in FIG. 2A, the active cursor navigation field 206 is identified by a dotted line around the target 204. In alternate embodiments, any suitable highlighting mechanism can be used. For example, size, font, shaping, line type, color, shadowing or a halo effect around the target may represent an active cursor navigation field. Alternatively, an active cursor navigation field may not be shown, visible to the user or have any highlighting or distinguishing features.

In one embodiment, an active cursor navigation field 206 may only be visible or highlighted when the cursor 202 is within a predetermined distance or range from a field 206. As the cursor 202 navigates the display, a field 206 will illuminate only when the cursor 202 passes within a certain distance. This can provide the user with a better indication of an intended or potential target 204.

In FIG. 2A, the cursor 202 is shown approaching the target 204 as well as the cursor navigation field 206. The cursor 202 can be moved in any suitable manner and the method an apparatus or device for moving the cursor shall not be limited by the embodiments disclosed herein. As shown in FIG. 2B, as the cursor 202 reaches the cursor navigation field 206, the cursor 202 will automatically be repositioned or transitioned towards or to an area 212 that is substantially in the center of the target 204. In alternate embodiments, the area 212 can be in an area other than the center of the target 204, for example on the perimeter of target 204. In one embodiment, the position of the area 212 is such that the underlying function of the target, such as a link to a webpage, field or document, can easily be selected and/or activated by the repositioned cursor 202. Thus, although the cursor 202 in FIG. 2B is shown as being in substantially the center of the target 204, in alternate embodiments the cursor 202 can be automatically repositioned from the cursor navigation field 206 to any suitable area on or about the target 204.

In one embodiment, it is possible to activate the underlying function related to a point of interest while the cursor is being dragged or re-positioned to the area 212 and not just when the cursor reaches the position 212. For example, the cursor 202 is engaged by a cursor navigation field 206. As the cursor 202 is being automatically transitioned to area 212, the function underlying the corresponding target 204 is automatically activated. The engagement of the cursor 202 with the respective navigation field 206 can be sufficient to activate the underlying application, link or function. This can be advantageous in a situation where the user does not wish to wait for the cursor 202 to be re-positioned. Alternatively, as the cursor 202 is being repositioned, the user can be prompted as to whether the underlying function should be activated.

Once the cursor 202 is repositioned to the target 204 as shown in FIG. 2B, the cursor 202 can be locked in that position for any suitable or desired period of time. For example, a time-out can be set wherein once the cursor 202 is re-positioned to the target 204, the cursor 202 is locked or fixed at that point for a pre-determined time period. In one embodiment this time-out or period could be 300 milliseconds, for example. In alternate embodiments any suitable timeout period can be set. The locking period is generally set so as to avoid the cursor “slipping away” or move from the desired point of interest before stopping the cursor movement. The locking period can be set to keep the cursor from moving through the target and eliminate the need for the user to have to stop the cursor movement in an extremely narrow time window. After the expiration of the time-out, it would be possible to freely move the cursor 202. In one embodiment, the user can be advised as to the duration of the lock or time-out period. For example, in one embodiment, a visual indicator, such as a pop-up window, can be presented in relation to the target 204. The pop-up window could include a timer or other count-down feature. Alternatively, the pop-up may appear as a bubble or other highlighting that gradually diminishes as the lock period expires. Once the lock period expires and the cursor 202 can be moved, the visual indicator or highlighting will disappear.

In one embodiment, once the cursor 202 is automatically repositioned to the target 204, the cursor navigation field 206 can be de-activated. This is shown in FIG. 2B by the lack of the dotted line around the target 204. Once the cursor navigation field 206 is de-activated, the cursor 202 can be freely moved in, around and out of the target area 204. The de-activation of the cursor navigation field can be limited to the field of the intended target or applied to all cursor navigation fields present on the display 200 of the device. For example, when there are a plurality of targets 204 present, only the field of the intended target 204 can be de-activated, and not all other targets. This can provide for seemingly uninterrupted transitioning if the cursor 202 is suddenly moved away from target 204 to another target, before the cursor navigation field 206 is re-activated. By maintaining the fields around other targets, even when one field is de-activated, cursor re-positioning can be seamlessly maintained amongst other targets. In one embodiment, the activation and de-activation of the navigation fields could be by way of a switch or other toggling mechanism. For example, the user could activate a key, hard or soft, to change navigation modes. One mode would allow free navigation while another mode would enable the automatic cursor positioning described herein. Another mode might enable 5-way navigation.

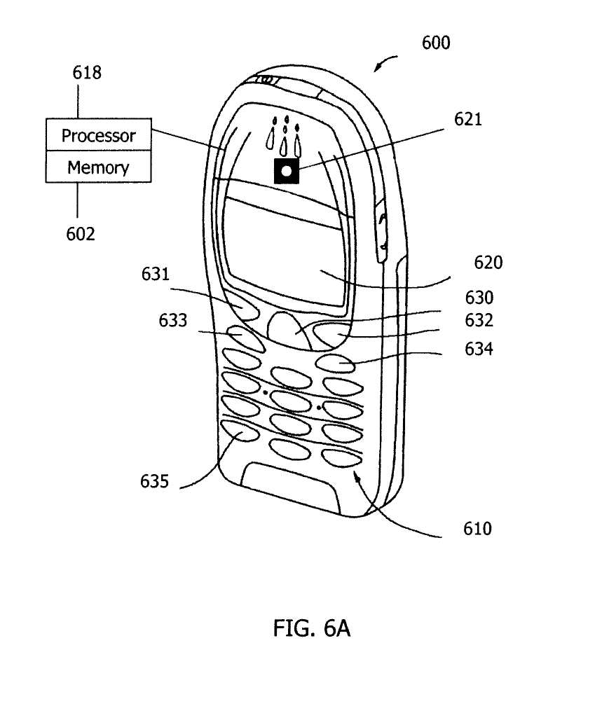

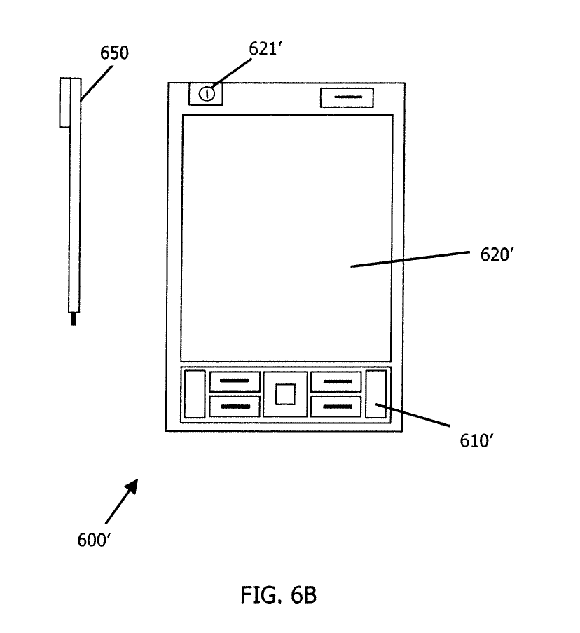

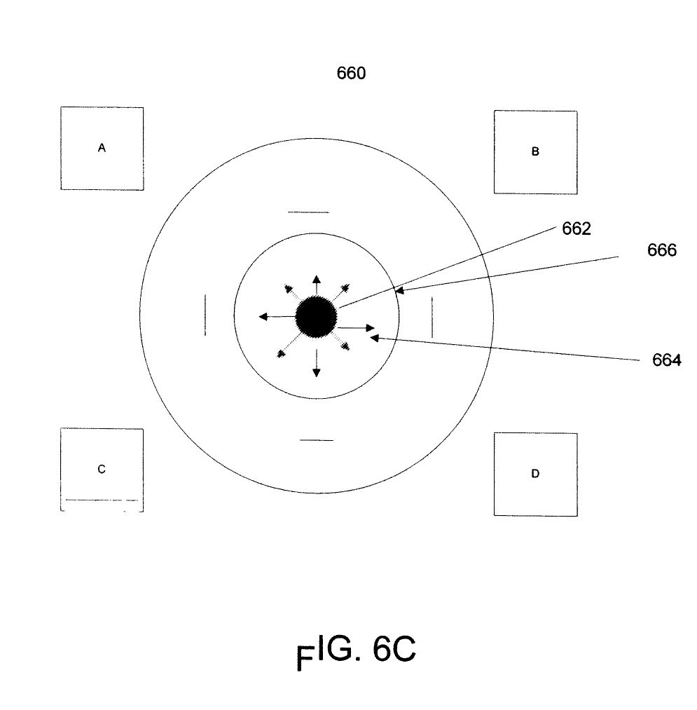

The disclosed embodiments can also allow a user to manually de-activate the cursor navigation assist feature. For example, a de-activation button or key can be provided that will allow the user to manually de-activate and activate the cursor navigation assist. This can be advantageous when navigating a web page with many links and where the user does not want to be interrupted by the assist feature until the cursor is very close to and intended target. Once the user is close to the target, the user can turn the feature back on. In one embodiment, an activate/de-activate function can be provided on a 360 degrees/analogue navigator 660, such as that shown in FIG. 6C. This can include a joystick control 662 for example. The user controls the movement and direction of the cursor using the joystick or control knob 662. Typically, the joystick 662 can be moved from a normal center position to any position within or around a 360 range. In alternate embodiments, the feature can be provided on any suitable cursor control device or mechanism, such as for example a gaming controller.

In one embodiment, the cursor 202 or device can be programmed or pre-defined to navigate to certain types of targets, as might be pre-defined by the user. For example, if the user is navigating in a map application, the user may only desire to locate tourist attractions or eating establishments. In a configuration menu of the corresponding device, the user can pre-set or pre-define this criterion. As the user navigates the user interfaces, the cursor 202 will only be automatically positioned to targets 204 that meet the pre-set criteria. In one embodiment, where a navigation field 206 is visible around a target 204, only those fields that surround a target 204 meeting the criteria will be highlighted. This can be particularly advantageous in an environment where there can be numerous potential targets. Non-desired targets, or target categories, can be filtered out in accordance with the aspects of the disclosed embodiments.

In one embodiment, a user can selectively de-activate cursor navigation fields around otherwise valid targets. For example, in one embodiment, it may be desirable for a user to include or exclude targets of a certain category. This can be accomplished by adjusting settings in a set-up or preferences menu of the device, for example. This can allow the user to visualize only desired targets, particularly where there might be more than one target or point of interest available. For example, in a map application, where there can many points of interests or links available, the user might set certain criteria for desired points of interest. If the user is only interested in museums or restaurants, the selection criteria can limit the creation or activation of cursor navigation fields to only around those points of interest. When navigating a web page, for example, the selection criteria can include only navigating to image links as desired targets, and not text. Thus, when the user is moving the cursor 202 across the display 200, the cursor 202 will only be drawn to the desired points of interest, and not all targets that might be available.

Once the cursor navigation field 206 is de-activated, field 206 can be re-activated either automatically or manually. For example, the cursor navigation field 206 can automatically be re-activated after the expiration of a pre-determined period of time. In one embodiment the cursor navigation field 206 can be re-activated by moving the cursor 202 away from the target 204. The movement of the cursor 202 away from the target 204 to reactivate the cursor navigation field may include moving the cursor 202 just past an outer perimeter edge of the cursor navigation field 206. For example, in one embodiment, the cursor navigation field 206 is reactivated when the cursor moves a pre-determined distance outside an area of the target 204 and a few pixels beyond an outer edge of the cursor navigation field 206.

In another embodiment, providing a field activation input to the device can re-activate the cursor navigation field. A cursor navigation field activation key can be provided in conjunction with the device that can be used to re-activate or de-activate the cursor navigation field 206. For example, when the cursor navigation field 206 has been de-activated, the key can be used to re-activate the field. In one embodiment, a user may use the input or key to re-activate the cursor navigation field in order to reposition or re-transition the cursor 202 back to center, when the cursor has been moved away from the center region or the original position.

The aspects of the disclosed embodiments provide for the cursor 202 to automatically be transitioned or repositioned from a point outside or on an edge of the target 204 to a predetermined position within the target 204 such as for example a center region. In one embodiment, the repositioning of the cursor 202 is a fast transition. Thus, once the cursor 202 reaches the cursor navigation field 206, the re-positioning of the cursor to within the target 204 appears to occur very quickly. This allows for a rapid and precise positioning of the cursor 202. In alternate embodiments the positioning speed or rate of the cursor can be any suitable speed or rate.

In one embodiment, a period of time can be set where a cursor 202 is within the general area, region or field of a cursor navigation field 206 before the cursor is automatically repositioned. This can allow a user a decision point prior to any repositioning of the cursor 202. For example, in one embodiment as shown in FIG. 2A, the cursor 202 is approaching an active cursor navigation field 206. The user moves the cursor 202 to within the area encompassed by the cursor navigation field 206. Instead of immediately automatically repositioning the cursor 202 within the area of the target 204, a delay can be implemented to allow the user to move, or remove the cursor 202 from the area of the cursor navigation field 206, if the target is not the intended or desired target. In one embodiment, the user can be provided with a notification that the cursor is within the cursor navigation field 206 of the target 204 prior to any repositioning. For example, when the cursor 202 reaches the cursor navigation field 206, a pop-up window may be displayed that advises the user of the location of the cursor 202. The notification may also inform the user of the target 204 and the target location for the cursor 202 once a repositioned. If the period of time expires without any further action by the user, the cursor 202 can automatically be repositioned to the target 204.

In one embodiment, a cursor navigation field 206 can include a perimeter region or area 207. As the cursor 202 is being drawn towards the field 206, the user can have an opportunity to keep the cursor 202 from being re-positioned to target 204 if a bypass control function is activated while the cursor 202 is in the perimeter region 207. The bypass control function could be the activation of a key, for example. This can provide a way to bypass an otherwise active point of interest, or target 204. In one embodiment, activation of the control function while the cursor 202 is in the perimeter area 207 will automatically move the cursor to an opposite side of the target 204, and away from the target 204. Alternatively, the activation of the bypass control function could cause the cursor 202 to move in the direction of the next, or closest, other target or point of interest. The perimeter area or region 207 can be of any suitable size or shape, and be positioned in any desired fashion with respect to the field 206. For example, in one embodiment, as the cursor 202 is moved towards a target 204, the field 206 may be highlighted. The perimeter area or region 207 may only appear or be functional along a portion of the navigation field 206 that coincides with the direction from which the cursor 202 is approaching. Thus, the region 207 may not extend along an entire perimeter of the field 206, but only a portion.

In one embodiment, as the user moves the cursor 202 towards a target 204, the target 204 can be highlighted if the cursor navigation field 206 can draw the cursor 202 to the target 204. This can be useful to inform the user as to which target 204 the cursor 202 is being drawn to and allow the user an opportunity to change or redirect the cursor 202. This can be especially useful on a display including a plurality of targets, such as shown in FIG. 2D. For example, the user is moving the cursor 202 towards an area that contains one or more targets 244a-244d . As the cursor 202 passes within a range of cursor navigation field 246b , the target 246b can be highlighted in some fashion to inform the user that the cursor 202 can be positioned on the target 246b if the cursor position is maintained at that point. If the user desires to position the cursor 202 substantially on or at target 246b (in order to activate the function) the current position of the cursor 202 can be maintained and the automatic repositioning as described herein can take place. On the other hand, if the user has another target intended, such as target 246d , the user can continue to move the cursor 202 in the direction of target 246d . In this way, as the user passes other targets along the way to an intended target, the user has the opportunity to select another target as described herein.

The size or area encompassed by the cursor navigation field 206 can be any suitable area. In a situation where there are only a few targets on the display 200, the area encompassed by the cursor navigation field 206 can be larger than in a situation where there are a number of targets shown on the display. In a situation where there are a number of targets on a display, traversing to the different targets enroute to a specific target can be cumbersome and confusing, particularly where there are active fields around each of these targets. For example, on a map, a user may need to traverse a number of different links or active areas in order to reach a desired point of interest. As the cursor 202 is moved near or over each of the active cursor navigation fields 206, there could be a tendency for the system to attempt to transition the cursor 202 to the corresponding target even though it may not be the desired or intended target. By limiting or adjusting a size of the cursor navigation field, unintended contact or re-positioning can be avoided. Similarly, in a situation where there are few targets, a larger cursor navigation field size will only require a minimal amount of movement on the part of the user to locate the cursor over the intended target.

In one embodiment, the speed or rate of movement of the cursor 202 can be used to activate or deactivate the cursor navigation fields 206. For example, in one embodiment, when the speed or rate of movement of the cursor 202 is at or exceeds a predetermined rate, all active cursor navigation fields 206 can be disabled. Thus, if the user knows the location of a desired target, the user can move the cursor 202 at or near the disabling rate until the cursor 202 reaches a point near or just prior to the desired target 204. Once the rate of movement of the cursor 202 slows to a point below the disabling rate, the cursor navigation fields 206 will once again become active. This will allow the user to cross or traverse a field of links or targets without stopping all the time or having the cursor 202 re-positioned to an un-intended target. In one embodiment, the de-activation feature can be implemented as a hardware threshold feature. For example, the 360 degrees navigator 660 shown in FIG. 6C may be implemented in such a way that maximum speed is achieved when the navigator control 662 is moved from the normal center position to a position 664 approximately halfway between the center position and the movement limit 666 of the control, or outer bounds. When the navigator control 662 such as button, knob or stick, is moved even further towards the movement limit position 666 of the control 662, which can also be referred to as the outer bound or edge of the 360 degree range, the bypass feature can be activated. Thus, in the case of a joystick control, when the joystick is moved from the normal center position to a position that is substantially at the limit of movement of the control, the bypass feature described above will automatically be activated. When the joystick is moved back towards the normal, center position, the bypass feature can be automatically disabled. In this example, the bypass feature is not dependent on speed, but rather on the threshold position of the control switch 662. In this case the bypass feature is dependent upon how close the navigator control switch is to the outer edge or bounds limit of the control. It is noted that the position of the navigator control switch does not have to be exact, and approximate positioning may be sufficient to activate the speed and bypass modes of the navigator control.

In one embodiment, different visual and audio indicators can be provided when the device engages the speed and bypass modes. For example, in one embodiment, the cursor can change shape or highlight between a normal mode and the speed and bypass modes. At the same time, or in lieu of, some audible indication can be provided, whether in the form of a single or intermittent sound, or a continuous sound. The indication may also be tactile. For example, the device may vibrate, buzz or pulse in a different mode. This can be particularly useful when the device is handheld. In alternative embodiments, a pop-up window may appear that indicates the particular state or mode.

Similar visual, audio and tactile features can be provided when the cursor 202 is attracted or drawn to a point of interest or target 204. For example, in one embodiment, a visual cue will inform the user of the intended target 204. The user may also be able to sense tactile feedback from the navigation control, such as for example the navigator 660 of FIG. 6C, as the cursor 202 is drawn to a target. This could be in the form of vibration or resistance with respect to the control or joystick 662. The user may sense resistance or ease of movement of the control 662 as the control 662 is pulled or drawn in the same/opposite direction of the target 204. Additionally, when the cursor 202 locks onto the target 204, further directional movement of the control 662 may have no effect until the control 662 is returned back to the normal, center position. Once the control 662 returns back to the normal position, subsequent movement of the control will be permitted.

In the embodiment where the navigation fields are disabled, the user can be provided with a visual, aural or tactile indication of this particular state of the device. This can include for example, pop-up window(s), a change in the appearance of the affected cursor navigation fields, highlighting of the affected cursor navigation fields, a change in the appearance or highlighting of the cursor as it approaches a disabled field, other some other suitable indicator or notification.

In one embodiment, when traversing a display that includes a plurality of targets 204, the “locking” time of the cursor 202 on a target 204 can be minimized when the cursor 202 is being moved at a higher rate of speed. Alternatively, the locking time can be minimized and/or disabled using a key or other switch. For example, where the cursor navigation fields 206 are not deactivated, as the cursor 202 enters a field 206, it will be repositioned as described herein. If the locking time of the cursor 202 at the repositioned point within the target is minimized or disabled, the user will be able to continue to move the cursor 202 towards the desired target in a relatively uninterrupted fashion. The cursor 202 will give the appearance of moving in a stepwise fashion towards an intended target.

In a situation where the display 200 of FIG. 2A includes a number or several targets 204 that are adjacent to or near each other, it may not be possible to have cursor navigation fields 206 that extend outside of or beyond an outer perimeter of each target 204. In one embodiment, each target 204 will have a cursor navigation field 206 that does not extend beyond or is coincident with an outer perimeter or edge of the target 204. In alternate embodiments the size of a cursor navigation field 206 in a crowded field of targets can be any suitable size. For example, in one embodiment the cursor navigation field 206 may be contained within, or substantially comprise the area occupied by the target 204. The cursor 202 moves or is transitioned into the area of the target 204 and the cursor navigation field 206.

In a situation where the target or link 204 is large in size, it may not be desirable to immediately move the cursor 202 to a center region of the target 204. In one embodiment, based on the size of the target 204, a determination can be made as to whether to move the cursor 202 to a center region of the target 204 or an intermediate position within the target 204. Or example, where the target is a large link the cursor or 202 can be drawn or repositioned to just inside an internal border of the active link area. The cursor 202 can then be moved around inside and outside of the link area. In some situations where the target is very large and precise positioning is not desirable or needed, the cursor navigation area 206 can automatically be disabled. For example, in one embodiment, links or targets that exceed a pre-determined size, area or resolution, can automatically be set to disable the automatic cursor positioning described herein. The determination of large targets can be based on or relative to the screen size and/or resolution of the display of the device.

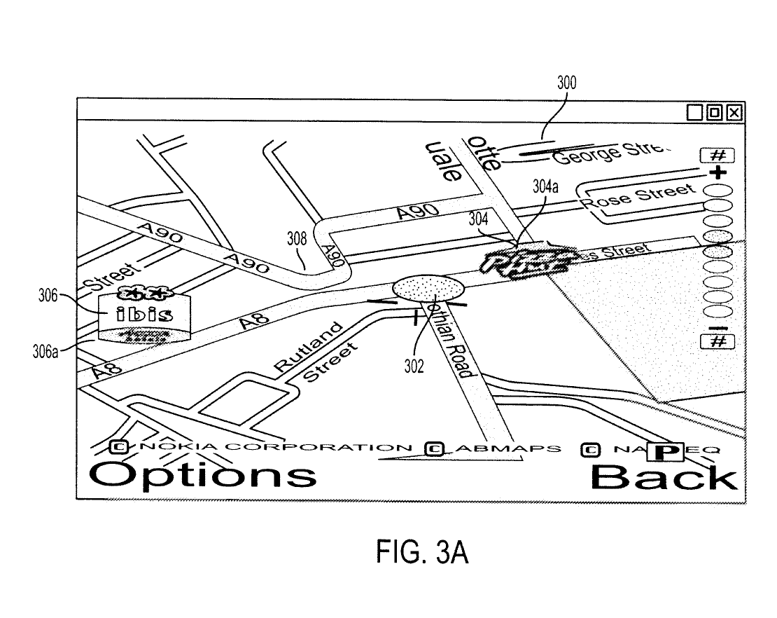

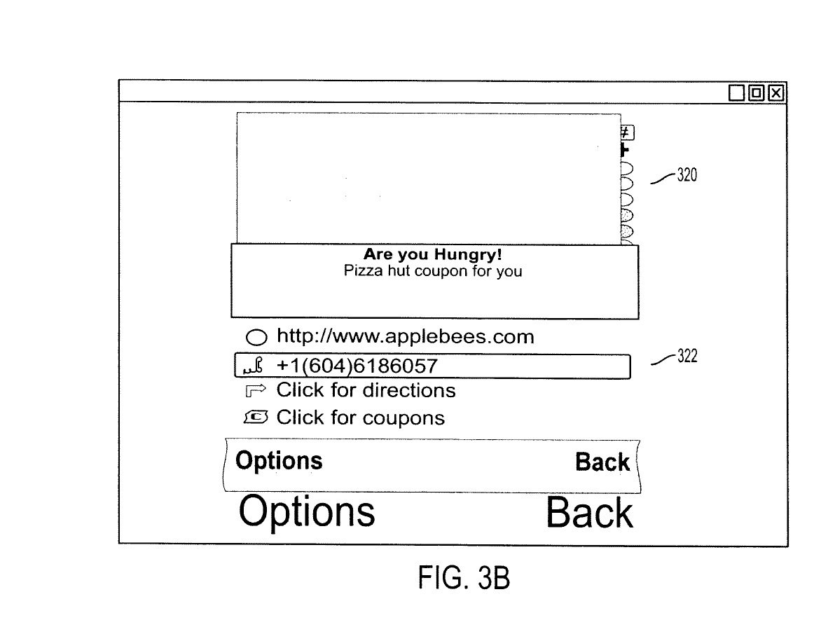

FIG. 3(a) illustrates one example of an application in which aspects of the disclosed embodiments can be practiced. In this example, the application is a map application 300 where a cursor 302 can be moved around the display 300. The map 300 can include static points of interest such as streets 308 as well as active links or dynamic points of interest such as 304 and 306. Points of interest 304 and 306 represent active links on the map that, when selected or activated, can open, render or access a webpage with more detailed information related to the point of interest.

In one embodiment, the map application 300 includes cursor navigation fields associated with each of the active points of interest 304 and 306. In this particular application or example, the cursor navigation fields corresponding to active points of interest 304 and 306 are shown as white squares or highlights 304a and 306a , respectively, around or in the background of the corresponding active point of interest. As the cursor 302 approaches the selectable item or target 304, the cursor 302 encounters the cursor navigation field 304a , which activates the automatic cursor positioning described herein. The cursor is automatically moved or drawn to the center of the target 304. The speed with which the cursor 302 is drawn to a predetermined area that is substantially the center region of the target 304 can be based upon an algorithm that takes into account factors such as for example, the size of the target 304, the current position of the cursor 302, speed or velocity of the cursor and the distance and direction to the target region. The center region can also be calculated based on a size and area of the target 304, and the location of the activatable link within the target 304. In alternate embodiments, any suitable process can be used to determine the transition speed and substantially center region of the target 304. The target or active point of interest 304 can then be selected, either manually by the user, or automatically. Selection of the target 304 can open the link to the corresponding webpage 320 shown in FIG. 3B. In this example, the webpage 320 includes more detailed information 322 related to the point of interest 304. By automatically positioning the cursor 302 on the target 304 to the user can easily navigate to and select the intended target. In this example, the positioning of the cursor 302 on the target 304 only needs to be such that the link associated with the target 304 can be activated in any suitable fashion. Similarly, had the user been navigating the cursor 302 towards target 306, upon encountering the corresponding cursor navigation area 306(a), the cursor 302 would have been positioned on the target 306 such that the target 306 could be or is selected in order to activate the link or open the webpage associated with the target. Although the examples described herein are in terms of opening a webpage associated with the target, in alternate embodiments, selection and activation of a link associated with the target can be used to open any suitable application. For example, in one embodiment, selection of the target 304 could open a document containing directions, a telephone number or a coupon, an image, multimedia message, or other program, for example, related to the target. The application or program could be stored on or in a memory of the device or remotely from the device.

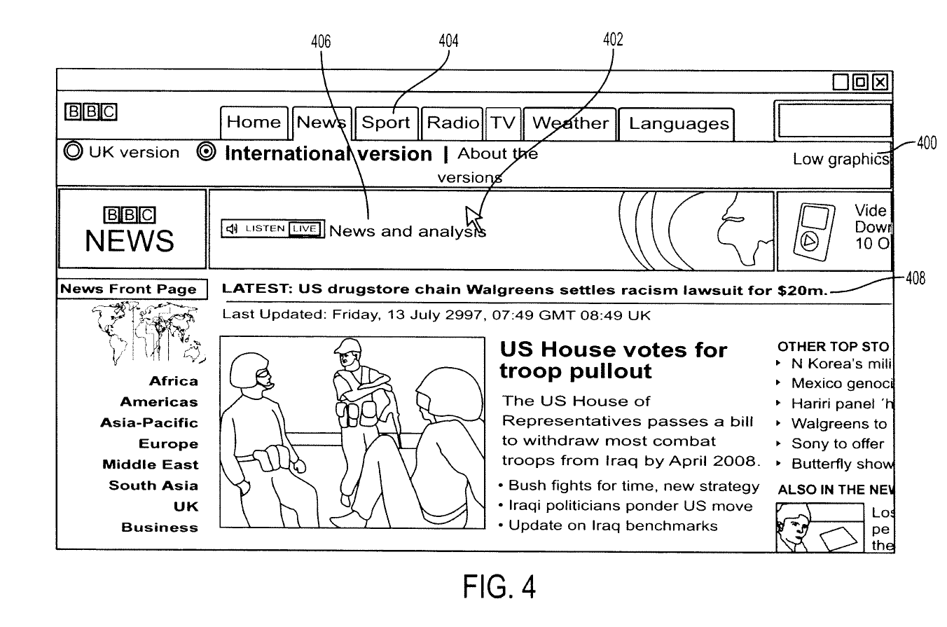

Another example is shown in FIG. 4, which is a web page 400 for a news service. As will be understood, a webpage can include a number of selectable and activatable links, examples of which are shown at references 404, 406 and 408. As the cursor or pointer 402 is moved toward a link, the pointer 402 will encounter a cursor navigation field that will appear to pull or draw the pointer 402 toward the link. The pointer 402 will automatically be positioned at a point that allows the link, such as link 406, to be next selected, either automatically or by activating a selection key.

In the example of FIG. 4, there are a number of selectable links 406. In one embodiment, the user can move the pointer 402 at a higher speed, which will deactivate all cursor navigation fields and allow the user to proceed directly to a point of interest. As the user approaches the intended target and slows the movement of the pointer 402, the cursor navigation fields will once again become active. In an alternate embodiment, disabling or minimizing the cursor lock period can allow the user to move the pointer or cursor across the display at a normal or slower speed and step through adjacent links. As the pointer 402 approaches a link 406, the pointer 402 will automatically be pulled towards a link 406 as described herein. Since the cursor locking period is minimized or disabled, the user will be able to move the pointer 402 towards the next link 404 in a seemingly uninterrupted fashion. In this way the user can step through adjacent links along a path to a desired link.

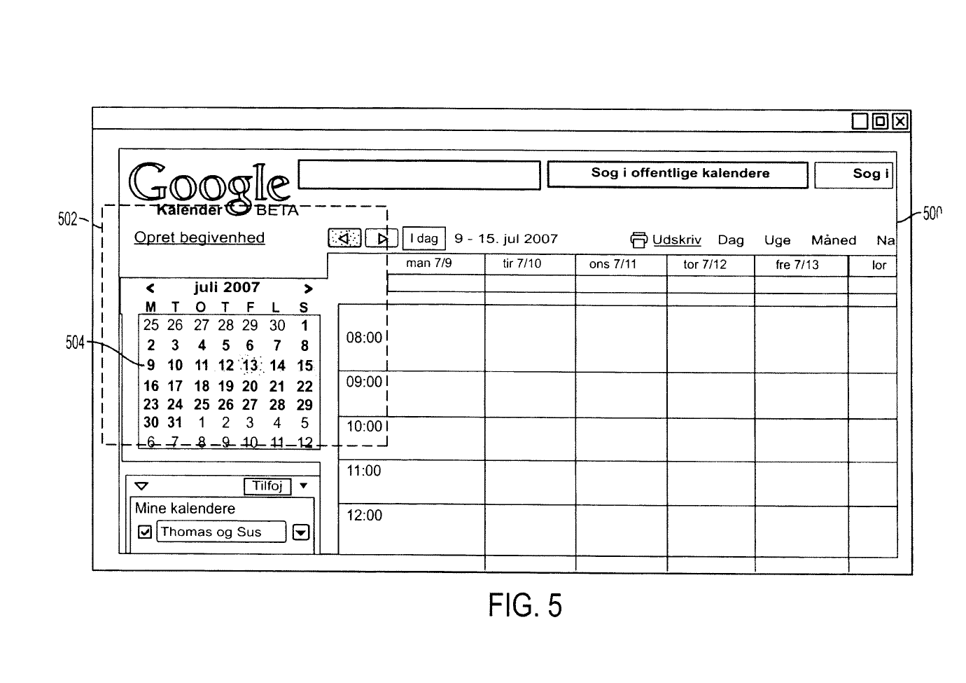

FIG. 5 illustrates another example of an application in which aspects of the disclosed embodiments can be practiced. As shown, the application comprises a calendaring application, and the calendar 500 is displayed. The calendar can have many selectable links. For example, on the calendar 502, each day 504 can comprise a selectable link. Selection of a link such as 504 can result in further data, such as schedules and appointments, relating to a particular day, week or other time period being displayed. Selecting a date generally allows the user to view appointments and calendar entries for the selected date or other time period. Each selectable link can have a related cursor navigation control field. However, it is important to be able to move easily to a specific link without having to stop at each other link. In this example, stepwise input is feasible by repeated horizontal movements or vertical movements. These movements can be controlled by for example joystick movements or clicks on a mouse, depending upon the type of analog navigation device being used.

Referring to FIG. 1, the system of the disclosed embodiments can include input device 104, output device 106, process module 122, applications module 180, and storage/memory 182. The components described herein are merely exemplary and are not intended to encompass all components that can be included in the system 100. The device 100 can also include one or more processors to execute the processes, methods and instructions described herein. The processors can be stored in the device 100, or in alternate embodiments, remotely from the device 100.

The input device 104 is generally configured to allow a user to input data and commands to the system or device 100. The output device 106 is configured to allow information and data to be presented to the user via the user interface 102 of the device 100. The process module 122 is generally configured to execute the processes and methods of the disclosed embodiments. The application process controller 132 can be configured to interface with the applications module 180 and execute applications processes with respects to the other modules of the system 100. The communication module 134 is configured to allow the device to receive and send communications and messages, such as text messages, chat messages and email. The communications module 134 is also configured to receive communications from other devices and systems.

The cursor navigation field module 136 is generally configured to generate the cursor navigation field 206 shown in FIG. 2A. The cursor transition module 137 is generally configured to interpret commands received from the field module 136, in conjunction with other inputs such as cursor location, and cause the cursor 202 in FIG. 2A to automatically transition to a point on the target 204 as described herein. The cursor transition module 137 can also adjust the transition speed as is described herein. The lock module 138 can establish the locking period for the cursor 202 as described herein, particularly with respect to the positioning of the cursor 202 on a target 204. The position calculation module 140 can be used to calculate a position of the cursor 202 relative to a cursor navigation field 206, and provide inputs for calculation of the target area and transition speeds. In one embodiment, the position calculation module 140 can conduct a real-time calculation when movement of the cursor is detected. Movement of the cursor can be in terms of determining a vector (angle and length) for the cursor movement. This information can be used by the position calculation module 140 to determine a direction of the cursor movement (e.g. up, down, left, right). This information can be transformed into (x, y) or (x, y, z) coordinates. The information together with the direction or vector can be transmitted to the cursor transition module 137 and navigation field module 136. Using the movement and coordinate position, a determination can be made whether to reposition the cursor 202 on a target 204 or other point of interest as described herein.

The applications module 180 can include any one of a variety of applications or programs that may be installed, configured or accessible by the device 100. In one embodiment the applications module 180 can include maps, web browser, office, business, media player and multimedia applications. The applications or programs can be stored directly in the applications module 180 or accessible by the applications module. For example, in one embodiment, an application or program is web based, and the applications module 180 includes the instructions and protocols to access the program and render the appropriate user interface and controls to the user.

In one embodiment, the system 100 comprises a mobile communication device. The mobile communication device can be Internet enabled. The input device 104 can also include a camera or such other image capturing system. The applications of the device may include, but are not limited to, data acquisition (e.g. image, video and sound) and multimedia players (e.g. video and music players) and gaming, for example. In alternate embodiments, the system 100 can include other suitable devices, programs and applications.

While the input device 104 and output device 106 are shown as separate devices, in one embodiment, the input device 104 and output device 106 can be combined and be part of and form the user interface 102. The user interface 102 can be used to display information pertaining to content, control, inputs, objects and targets as described herein.

The display 114 of the system 100 can comprise any suitable display, such as a touch screen display, proximity screen device or graphical user interface. The type of display is not limited to any particular type or technology. In other alternate embodiments, the display may be any suitable display, such as for example a flat display 114 that is typically made of a liquid crystal display (LCD) with optional back lighting, such as a thin film transistor (TFT) matrix capable of displaying color images.

In one embodiment, the user interface of the disclosed embodiments can be implemented on or in a device that includes a touch screen display or a proximity screen device. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

Some examples of devices on which aspects of the disclosed embodiments can be practiced are illustrated with respect to FIGS. 6A and 6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and a scroll function can be used to move to and select item(s), such as the targets 204 described with reference to FIG. 2A.

As shown in FIG. 6A, in one embodiment, the terminal or mobile communications device 600 may have a keypad 610 as an input device and a display 620 for an output device. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621 as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection and other input and commands. In alternate embodiments any suitable pointing or touch device, or other navigation control may be used. In other alternate embodiments, the display may be a conventional display. The device 600 may also include other suitable features such as, for example a loud speaker, tactile feedback devices or connectivity port. The mobile communications device may have a processor 618 connected or coupled to the display for processing user inputs and displaying information on the display 620. A memory 602 may be connected to the processor 618 for storing any suitable information, data, settings and/or applications associated with the mobile communications device 600.

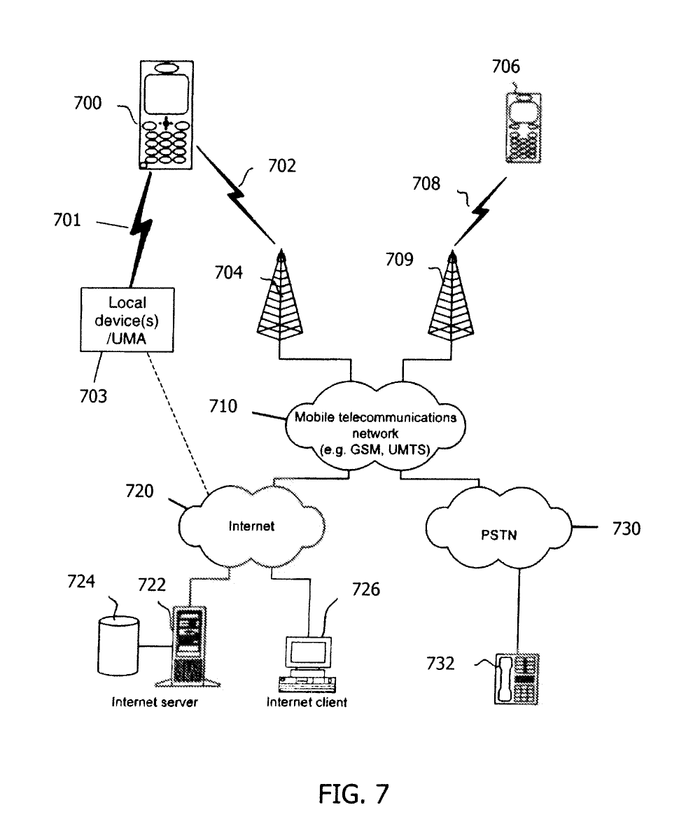

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 700 and other devices, such as another mobile terminal 706, a line telephone 732, a personal computer 751 and/or an internet server 722.

In one embodiment the system is configured to enable any one or combination of chat messaging, instant messaging, text messaging and/or electronic mail. It is to be noted that for different embodiments of the mobile terminal 700 and in different situations, some of the telecommunications services indicated above may or may not be available. The aspects of the disclosed embodiments are not limited to any particular set of services or applications in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. A server, such as Internet server 722 can include data storage 724 and processing capability and is connected to the wide area network 720, as is an Internet client 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communications module 134 that is configured to interact with, and communicate to/from, the system described with respect to FIG. 7.

Although the above embodiments are described as being implemented on and with a mobile communication device, it will be understood that the disclosed embodiments can be practiced on any suitable device incorporating a display, processor, memory and supporting software or hardware. For example, the disclosed embodiments can be implemented on various types of music, gaming and/or multimedia devices. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and GPS capability.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, establishing and selecting search and relationship criteria and navigating among the search results. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages and notifications. Depending on the inputs, the process module 122 interprets the commands and directs the process control 132 to execute the commands accordingly in conjunction with the other modules, such as cursor navigation field module 136, cursor transition module 137, lock module 138 and position calculation and determination module 140. In accordance with the embodiments described herein, this can include moving the cursor 202 towards a target 204, encountering a cursor navigation field 206 and automatically transitioning the cursor 202 to a point on the target 204.

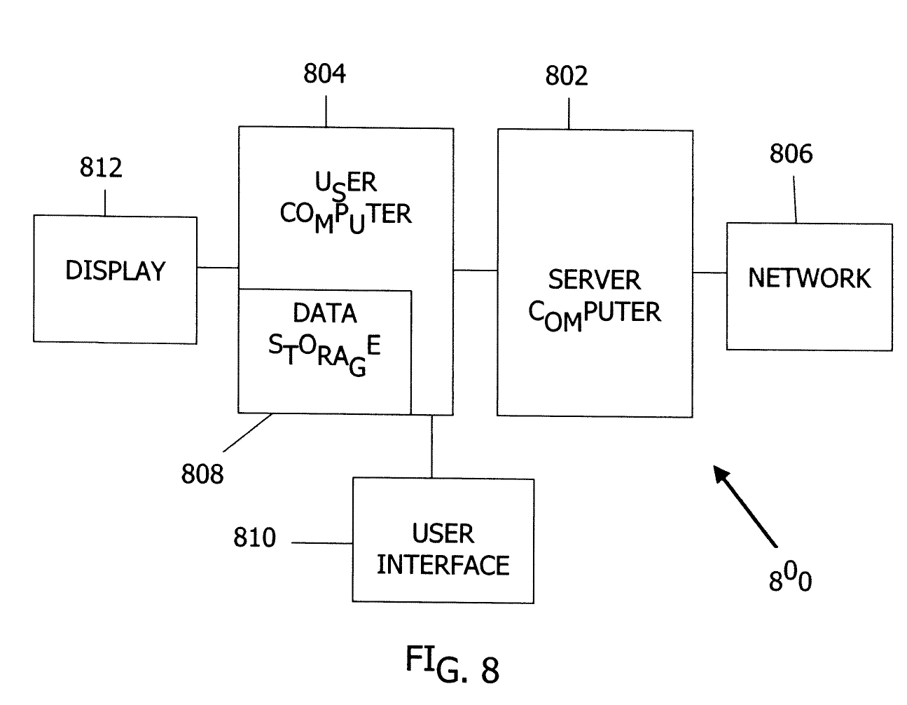

The disclosed embodiments may also include software and computer programs incorporating the process steps and instructions described above. In one embodiment, the programs incorporating the process steps described herein can be stored on and/or executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or a memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or through a dial-up connection on an integrated services digital network (ISDN) line or other such communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks, memory sticks, flash memory devices and other semiconductor devices, materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

The aspects of the disclosed embodiments are directed to improving navigation speed and precision in and around targets on a display of a device. A cursor navigation field is provided around targets that will automatically position a cursor or pointer in an appropriate spot on a target so that the target can be activated, either manually or automatically. The target is typically a selectable item or point of interest. By moving the cursor towards or to the target, the intended target, or an underlying function of the target, can easily be selected. This can be especially helpful with devices with smaller screen areas where precision navigation can be cumbersome or difficult. The cursor can be automatically dragged to the target leaving only the selection or activation of the underlying link to the user, if the process is not automatic.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
transitioning a cursor on a display towards a target;
detecting an active cursor navigation control field around the target; and
automatically positioning the cursor in a center region of the target when the cursor reaches the cursor navigation control field; and locking the cursor in the center region of the target for a predetermined period of time.

2. The method of claim 1 further comprising enabling free movement of the cursor after the predetermined period of time.

3. The method of claim 1 further comprising, after the cursor is positioned to the center region, allowing the cursor to be freely moved.

4. The method of claim 1 further comprising the de-activating the cursor navigation control field after the cursor is positioned in the center region of the target area.

5. The method of claim 1 further comprising:
detecting that a transition velocity of the cursor exceeds a predetermined limit;
de-activating all active cursor navigation control fields; and
re-activating deactivated cursor navigation control fields when the transition velocity of the cursor is less than the predetermined limit.

6. The method of claim 1 comprising:
determining that a transition velocity of the cursor exceeds a predetermined limit; and
allowing the cursor to move across active cursor navigation control fields while the transition velocity exceeds a predetermined limit.

7. The method of claim 6 further comprising allowing the cursor to lock to a next active cursor navigation control field when the transition velocity of the cursor is less than the predetermined limit.

8. The method of claim 1 wherein the cursor navigation control field comprises a region surrounding the target.

9. The method of claim 1 wherein an outer edge of the cursor navigation control field coincides with an outer perimeter of the target.

10. The method of claim 1 further comprising, if the target exceeds a predetermined size, de-activating the cursor navigation control field.

11. The method of claim 1 further comprising:
selecting one or more targets on a display of a device;
establishing a cursor navigation control field around each target wherein each target has a target area and a navigation control field area.

12. The method of claim 1 further comprising displaying a perimeter of the cursor navigation control field on the display when the cursor navigation control field is active.

13. The method of claim 1 wherein the device is a mobile communications terminal.

14. The method of claim 1 wherein the target is a link to a website.

15. The method of claim 1 wherein the target is a point of interest on a map.

16. The method of claim 1 comprising, when the display includes a plurality of targets, highlighting an active cursor navigation control region that is nearest the cursor.

17. The method of claim 16 wherein the active cursor navigation control region that is highlighted is also in a direction of movement of the cursor.

18. An apparatus comprising:
a display unit;
a navigation control unit coupled to the display and configured to enable movement of a selection object on the display unit; and
a processor in the apparatus coupled to the navigation control unit, the processor being configured to:
detect a movement of the selection object towards a target presented on the display unit;
detect a proximity of the selection object to a cursor navigation field corresponding to the target;
automatically transitioning the selection object to an activatable link of the target when the selection object reaches a pre-determined distance with respect to the cursor navigation field; and
lock the cursor in the center region of the target for a predetermined period of time.

19. The apparatus of claim 18 wherein the processor is further configured to enable free movement of the cursor after the predetermined period of time.

20. The apparatus of claim 18 wherein the processor is further configured, after positioning the cursor to the center region, to allow the cursor to be freely moved about the display.

21. The apparatus of claim 18 wherein the processor is further configured to de-activate the cursor navigation control field after the cursor is positioned in the center region of the target area.

22. The apparatus of claim 18 wherein the apparatus comprises a mobile communication device.

23. A computer program product stored in a memory comprising computer readable program code embodied in a computer readable medium for executing the method of claim 1.

24. The computer program product of claim 23 wherein the computer readable program code is stored in a memory of a mobile communications device.

25. A user interface comprising:
a display area, the display area being configured to present at least one selectable item on the display area;
a navigation control device, the navigation control device being configured to allow movement of an object selection tool on the display area; and
an object selection tool positioning area related to each selectable item, the object selection tool positioning area enabling automatic positioning of the object selection tool in an activatable region of the at least one selectable item when the navigation control device causes the object selection tool to engage a corresponding object selection tool positioning area.

26. The user interface of claim 25 further comprising a highlighting device configured to highlight each active object selection tool positioning area in the display area.

27. The user interface of claim 25 further comprising that each active selectable area is automatically highlighted as the object selection tool is moved to within a pre-determined distance from the active selectable area.

28. The user interface of claim 25 further comprising a navigation control that transitions the object selection tool at a first transition speed about the display when the navigation control is in a first position and disables each active selectable area when the navigation control is in a second position.

29. The user interface of claim 28 wherein the first position is an intermediate position of the navigation control between a neutral position and an outer limit, and the second position is the outer limit of the navigation control.
